(19) United States
(12) Patent Application Publication
(10) Pub. No.: US 2007/0153742 A1
(43) Pub. Date: Jul. 5, 2007

(54) Method, apparatus, software, and system for handover

(76) Inventors: Benoist Sebire, Beijing (CN); Tsuyoshi Kashima, Yokohama (JP)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/649,742

(22) Filed: Jan. 3, 2007

Related U.S. Application Data
(60) Provisional application No. 60/756,118, filed on Jan. 3, 2006.

(51) Int. Cl. H04Q 7/00

(52) U.S. Cl. 370/331; 455/436; 370/352

(57) ABSTRACT

A method is presented for handing over a mobile device from a source base station to a target base station. A plurality of service data units are segmented, in the source base station, at a medium access control layer. The segments produced by the segmentation are transmitted, after which a handover command is issued to a user device. The segmentation can alternatively be performed at the user device.

### CROSS-REFERENCE TO RELATED APPLICATION

The present invention is based upon and claims priority to Provisional U.S. patent application Ser. No. 60/756,118 titled “Boundary for Handover” which was filed on Jan. 3, 2006.

### FIELD OF INVENTION

The present invention relates generally to wireless communications, and more particularly to handovers in a wireless communications network.

### BACKGROUND OF INVENTION

The telecommunications industry is in the process of developing a new generation of flexible and affordable communications that includes high-speed access while also supporting broadband services. Many features of the third generation mobile telecommunications system have already been established, but many other features have yet to be perfected.

One of the systems within the third generation of mobile communications is the Universal Mobile Telecommunications System (UMTS) which delivers voice, data, multimedia, and wideband information to stationary as well as mobile customers. UMTS is designed to accommodate increased system capacity and data capability. Efficient use of the electromagnetic spectrum is vital in UMTS. It is known that spectrum efficiency can be attained using frequency division duplex (FDD) or using time division duplex (TDD) schemes. Space division duplex (SDD) is a third duplex transmission method used for wireless telecommunications.

As can be seen in FIG. 1, the UMTS architecture consists of user equipment 102 (UE), the UMTS Terrestrial Radio Access Network 104 (UTRAN), and the Core Network 126 (CN). The air interface between the UTRAN and the UE is called Uu, and the interface between the UTRAN and the Core Network is called Iu.

The UTRAN consists of a set of Radio Network Subsystems 128 (RNS), each of which has geographic coverage of a number of cells 110 (C), as can be seen in FIG. 1. The interface between the subsystems is called lur.

Each Radio Network Subsystem 128 (RNS) includes a Radio Network Controller 112 (RNC) and at least one Node B 114, each Node B having geographic coverage of at least one cell 110. As can be seen from FIG. 1, the interface between an RNC 112 and a Node B 114 is called Iub, and the Iub is hard-wired rather than being an air interface. For any Node B 114 there is only one RNC 112. A Node B 114 is responsible for radio transmission and reception to and from the UE 102 (Node B antennas can typically be seen atop towers or preferably at less visible locations). The RNC 112 has overall control of the logical resources of each Node B 114 within the RNS 128, and the RNC 112 is also responsible for handover decisions which entail switching a call from one cell to another or between radio channels in the same cell.

LTE, or Long Term Evolution (also known as 3.9G), refers to research and development involving the Third Generation Partnership Project (3GPP) aimed at identifying technologies and capabilities that can improve systems such as the UMTS. The present invention is related to LTE work that is taking place in 3GPP.

Generally speaking, a prefix of the letter “E” in upper or lower case signifies LTE, although this rule may have exceptions. The E-UTRAN consists of eNBs (E-UTRAN Node B), providing the E-UTRA user plane (RLC/MAC/PHY) and control plane (RRC) protocol terminations towards the UE. The eNBs interface to the access gateway (aGW) via the S1, and are inter-connected via the X2.

An example of the E-UTRAN architecture is illustrated in FIG. 2. This example of E-UTRAN consists of eNBs, providing the E-UTRA user plane (RLC/MAC/PHY) and control plane (RRC) protocol terminations towards the UE. The eNBs are interconnected with each other by means of the X2 interface. The eNBs are also connected by means of the S1 interface to the EPC (evolved packet core) more specifically to the MME (mobility management entity) and the UPE (user plane entity). The S1 interface supports a many-to-many relation between MMEs/UPEs and eNBs. The S1 interface supports a functional split between the MME and the UPE. The MMU/UPE in the example of FIG. 2 is one option for the access gateway (aGW).

In the example of FIG. 2, there exists an X2 interface between the eNBs that need to communicate with each other. For exceptional cases (e.g. inter-PLMN handover), LTE_ACTIVE inter-eNB mobility is supported by means of MME/UPE relocation via the S1 interface.

The eNB may host functions such as radio resource management (radio bearer control, radio admission control, connection mobility control, dynamic allocation of resources to UEs in both uplink and downlink), selection of a mobility management entity (MME) at UE attachment, routing of user plane data towards the user plane entity (UPE), scheduling and transmission of paging messages (originated from the MME), scheduling and transmission of broadcast information (originated from the MME or O&M), and measurement and measurement reporting configuration for mobility and scheduling. The MME/UPE may host functions such as the following: distribution of paging messages to the eNBs, security control, IP header compression and encryption of user data streams; termination of U-plane packets for paging reasons; switching of U-plane for support of UE mobility, idle state mobility control, SAE bearer control, and ciphering and integrity protection of NAS signaling.

The present invention is related to handovers in LTE, although the solution of the present invention may also be applicable to present and future systems other than LTE. Because the physical layer cannot accommodate all possible service data unit (SDU) sizes, SDUs have to be segmented before transmission over the radio link.

The main problem is how to ensure a lossless handover (HO) when SDUs are segmented in the base station (BS). According to related art, in order to ensure a lossless handover, it has been proposed to introduce some control messages, for example related to medium access control (MAC) automatic repeat request (ARQ) and MAC segmentation, in order to facilitate communication between the source and target BS. For instance, the target BS would be given information about the correctly received segments and the missing ones.

The problems of such a prior art solution are at least twofold. First, if the PDU size on which the segmentation is based is not fixed, it may not be possible to retransmit the exact same missing segments at the target BS. Re-segmentation will be required. Second, this prior art solution increases not only traffic in the network but also the complexity of the system. MAC entities in different BSs need to exchange control messages.

### SUMMARY OF INVENTION

From a user/application viewpoint, performing handover during the MAC SDU (IP packet) transmission just introduces the handover processing latency to the SDU delivery if the HO can wait for a while. If there are intervals between IP packet arrivals, the impact becomes clear.

According to an embodiment of the present invention, the handover (HO) is limited at the service data unit (SDU) boundary. For handovers in LTE, an exemplary embodiment of the invention provides for segmentation to take place at the base station. In order to meet the established LTE requirements in terms of latency and data rate, the present invention provides that such a segmentation would take place right before radio transmission, in the base station (BS), as opposed to in a central node as is the case in the pre-LTE UTRAN (segmentation at RLC layer in RNC). Therefore, SDUs (e.g. IP packets) would be segmented at the medium access control (MAC) layer or radio link control (RLC) layer in the base station before transmission over the radio link.

A primary improvement here is that a lossless handover is ensured without segment forwarding or HARQ/ARK status information exchange between the source base station and the target base station. This invention has the advantage of being a simple system which does not increase traffic. Also, from a user/application point of view, delay introduced by a handover (HO) can be reduced.

In the downlink, segmentation of a new SDU is stopped when a handover decision is made, and the base station waits for all pending segments to be transmitted before issuing the handover command to the user equipment (UE). In the uplink, segmentation of a new SDU is stopped when the handover command is received and the UE waits for all pending segments to be correctly received by the source BS before executing the HO command and moving to the target BS. According to an exemplary embodiment of this invention, SDU segmentation takes place right before radio transmission, in the base station (e.g. in the eNB).

### BRIEF DESCRIPTION OF THE DRAWINGS

FIG. 1 shows a UTRAN system with a user equipment according to an exemplary embodiment of the present invention.

FIG. 2 shows an LTE system with a user equipment according to an exemplary embodiment of the present invention.

FIG. 3 shows an example of message flows on the BS side, with an SDU-boundary-aware HO procedure on the BS side.

FIG. 4 shows an example of message flows on the UE side, with SDU-boundary-aware HO procedure on the UE side.

FIG. 5 is a flow chart illustrating a method according to an exemplary embodiment of the present invention.

FIG. 6 is a block diagram of an apparatus according to an exemplary embodiment of the present invention.

### DETAILED DESCRIPTION OF A PREFERRED EMBODIMENT

A preferred embodiment of the present invention will now be described. This is merely to illustrate one way of implementing the invention, without limiting the scope or coverage of what is described elsewhere in this application.

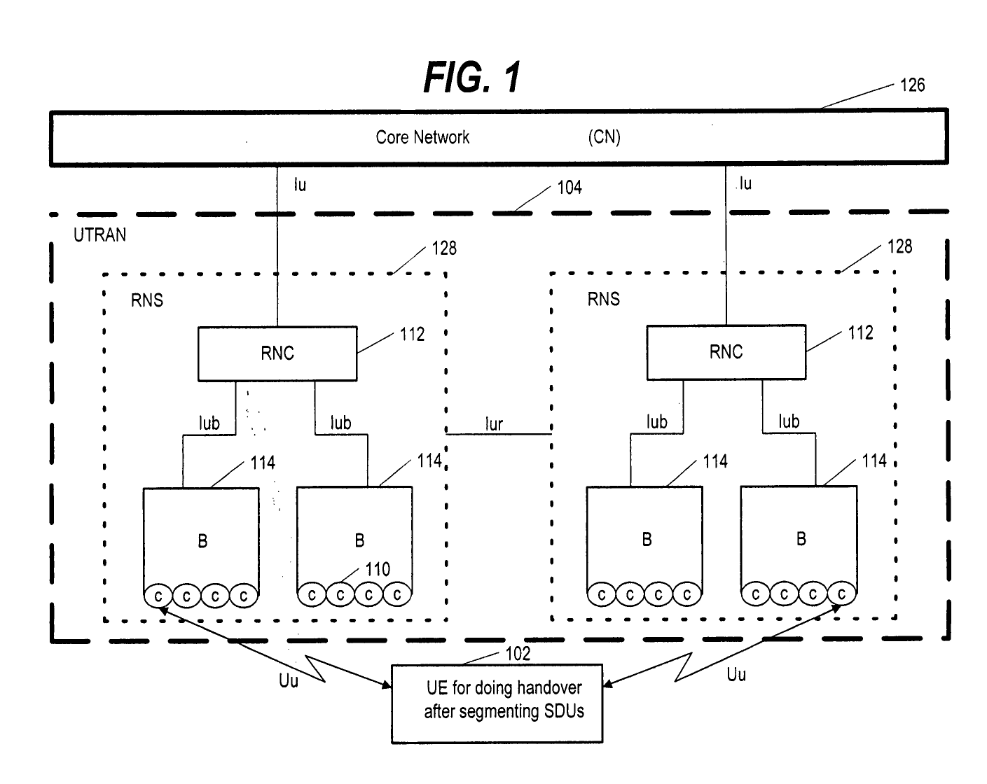

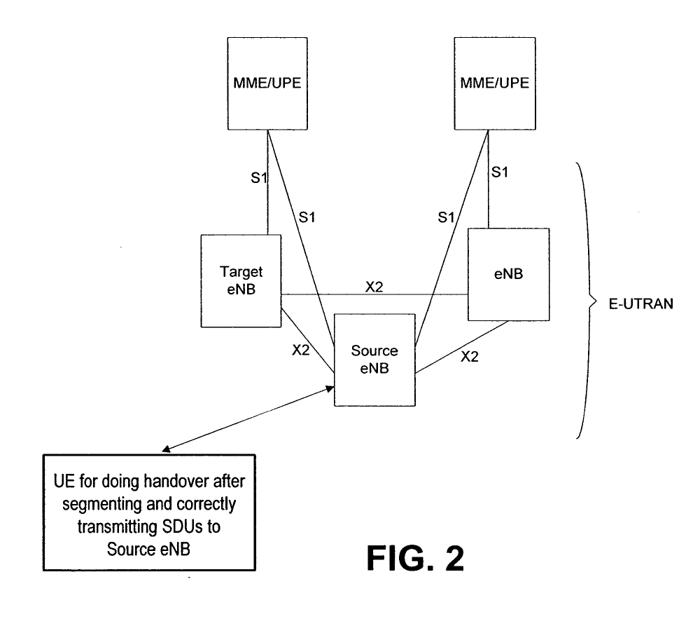

As mentioned, the invention includes two principles, for the downlink (DL) and uplink (UL) respectively. First, in the downlink, the segmentation of a new SDU is stopped when a HO decision is taken and the BS waits for all pending segments to be transmitted before issuing the HO command to the UE. Second, in the uplink, the segmentation of a new SDU is stopped when the HO command is received and the UE waits for all pending segments to be correctly received by the source BS before executing the HO command and moving to the target BS. The second principle is exemplified by the UE in FIG. 1 and FIG. 2, which does handover after segmenting the SDUs.

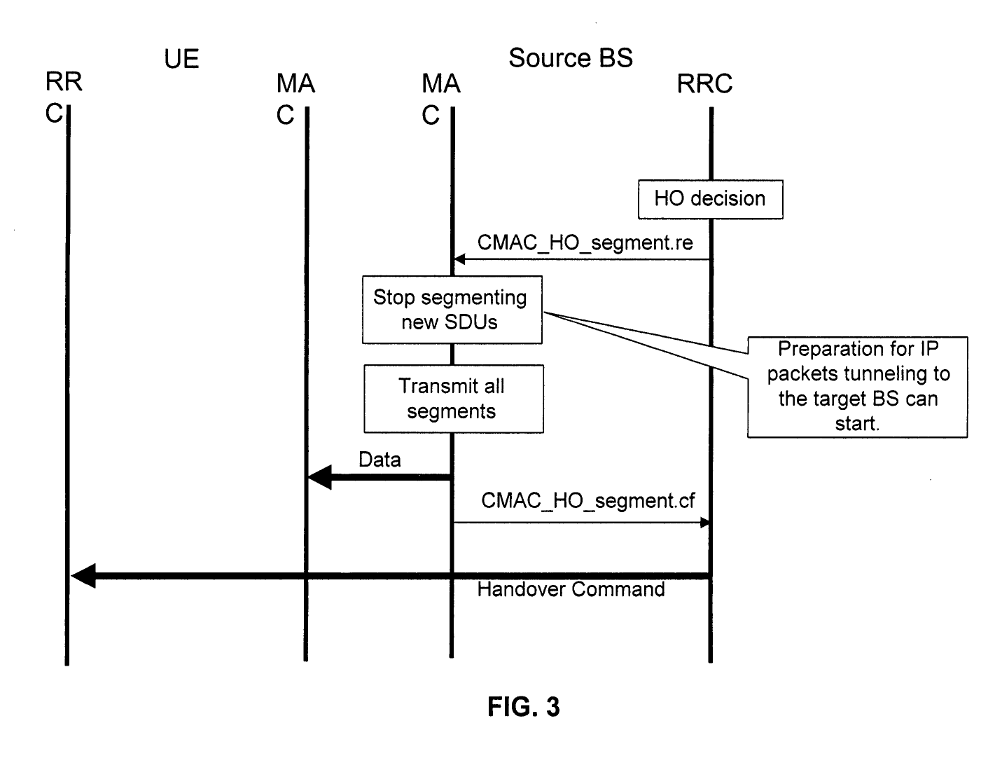

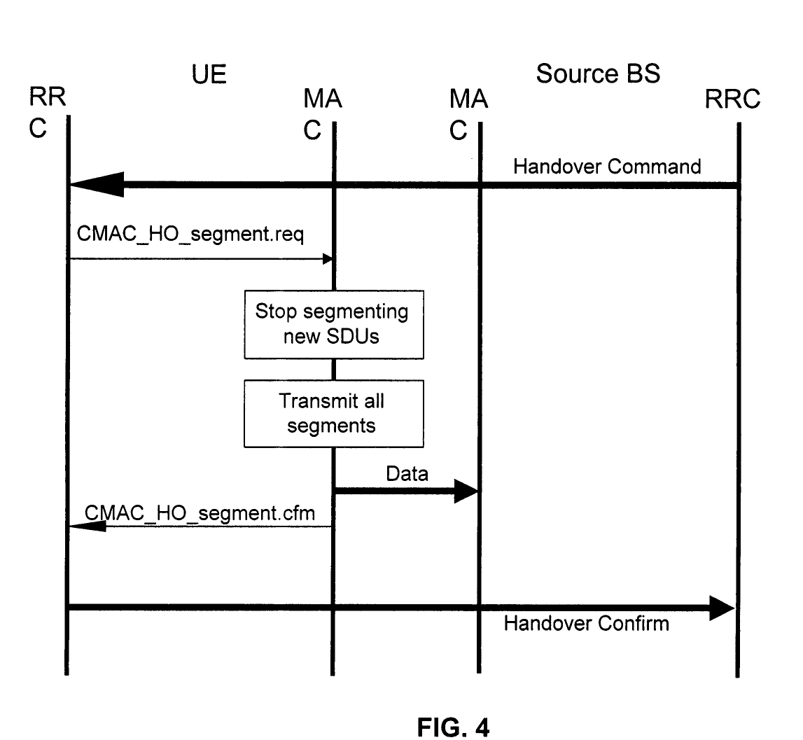

An illustrative message flow is shown in FIG. 3 for the BS side (i.e. the first principle). An illustrative message flow is shown in FIG. 4 for the UE side (i.e. the second principle).

Depending on the urgency of the HO, the network and the UE may decide not to apply these two principles just described. When they decide not to apply their own principle, the whole SDU would be normally retransmitted at the target BS. Note that a second, less-preferred option is this: If MAC or RLC (i.e. MAC/RLC) segment retransmission is supported, it is possible that the source BS delivers the MAC/RLC ARQ and segmentation information to the target BS, and the target BS transmits the MAC/RLC segment as the same way as in the prior art.

In any event, at least in the acknowledged mode, all MAC/RLC SDUs remaining in the buffers are tunnelled/transferred from the source BS to the target BS. This is because all acknowledged MAC/RLC SDUs are already removed from the buffer, and all other SDUs will require transmission or may require retransmission at the target BS.

Alternatively a threshold could be configured to limit the two principles described above to the cases where only a given percentage or number of segments are missing.

Of course, a person skilled in the art will understand that the UL and DL principles may not be applied together. For instance, only the DL part could be used.

The advantages of this present invention include the fact that it is a relatively simple system. It does not increase the traffic, and from the user/application viewpoint, the delay introduced by HO can be reduced.

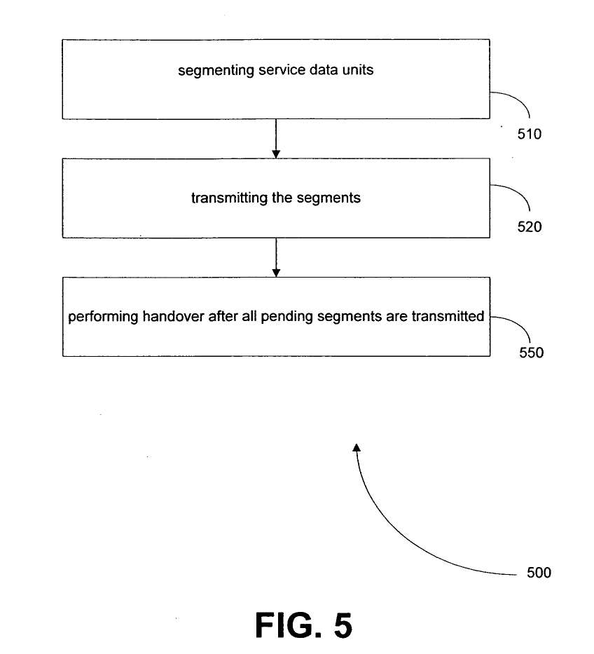

As seen in the embodiment shown in FIG. 5, the method 500 includes segmentin 510 the SDUs. All of the pending segments are transmitted 520. Then and only then, the handover is performed 550.

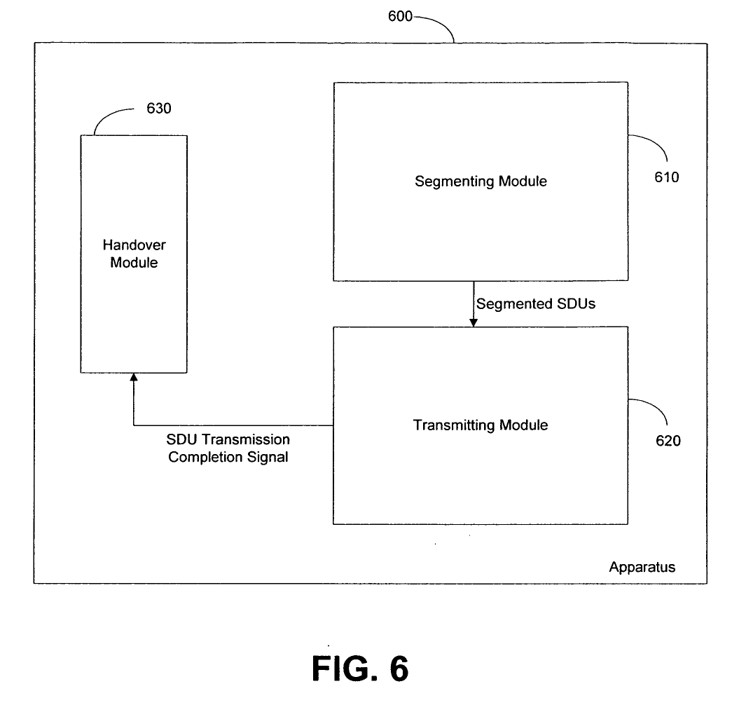

Turning now to FIG. 6, an apparatus 600 is shown. This apparatus may be located as a network element at the source base station, or alternatively can be located in the user equipment. A segmenting module 610 segments the SDUs, which are then transmitted over a wireless link by the transmitting module 620. When all pending SDUs have been transmitted, a handover module 630 is alerted, so that handover will be performed.

For the case where the apparatus 600 is located at the network side, the present invention includes a method of handover from the source base station to a target base station, which comprises segmenting a plurality of service data units in the source base station, at a medium access control layer, transmitting segments produced by the segmenting step, and issuing a handover command to a user device after the segments are transmitted. This exemplary embodiment of the method also includes stopping the segmenting when a handover decision is taken (i.e. made). After stopping the segmenting, transmission of the pending segments is completed, and then the handover command is issued. A threshold may be configured that limits the method to cases in which only a given percentage or number of segments are missing.

The embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor comprising a single processing unit, multiple processing units capable of parallel operation, or the CPU can be distributed across one or more processing units in one or more locations, e.g., on a client and server. A memory may comprise any known type of data storage and/or transmission media, including magnetic media, optical media, random access memory (RAM), read-only memory (ROM), a data cache, a data object, etc. Moreover, similar to the CPU, the memory may reside at a single physical location, comprising one or more types of data storage, or be distributed across a plurality of physical systems in various forms. In the context of FIG. 6, a person skilled in the art will understand that a memory unit can be used to store segmented SDUs until they can all be transmitted by transmitting module 620.

It is to be understood that the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein. Of course, as mentioned above, the solution of the present invention may also be applicable to present and future systems other than LTE.

What is claimed is:

1. A method comprising:
segmenting a plurality of service data units;
transmitting segments produced by the segmenting; and
performing a handover procedure after the segments are transmitted,
wherein the handover is for handing a user device from a source base station over to a target base station.

2. The method of claim 1, wherein the segmenting is performed at the source base station, and wherein the handover procedure comprises issuing a handover command to the user device after the segments are transmitted.

3. The method of claim 2, also comprising stopping the segmenting if a handover decision is made,
wherein the handover procedure is performed only after all of the segments that are pending have been transmitted.

4. The method of claim 1, wherein the segmenting is performed at the user device, and wherein the handover procedure comprises providing a handover confirmation after the segments are transmitted.

5. The method of claim 4, also comprising stopping the segmenting if a handover command is received,
wherein the handover procedure is performed only after all of the segments that are pending have been transmitted.

6. The method of claim 1, wherein a threshold is configured that limits the method to cases in which only a given percentage or number of segments are missing.

7. The method of claim 1, wherein the segmenting occurs at a medium access control layer.

8. The method of claim 1, wherein the source base station and the target base station are Node Bs within a long term evolution wireless network,
wherein the user device is a mobile terminal having at least one wireless connection with the network, and
wherein the segments are transmitted via said at least one wireless connection.

9. The method of claim 4, wherein the handover procedure also includes complying with the handover command, and
wherein the handover procedure is performed only after an acknowledgment is received that all of the segments that are pending have been received by the source base station.

10. The method of claim 1, wherein the segments are wirelessly transmitted between the user device and the source base station.

11. The method of claim 3, wherein if the handover decision is made, preparations are started for tunneling packets to the target base station.

12. An apparatus comprising:
means for segmenting a plurality of service data units;
means for transmitting segments produced by the segmenting means; and
means for performing a handover procedure after the segments are transmitted,
wherein the handover is for handing a user device from a source base station over to a target base station.

13. The apparatus of claim 12, wherein the apparatus is a network element located at the source base station, and wherein the handover procedure comprises issuing a handover command to the user device after the segments are transmitted.

14. The apparatus of claim 13, also comprising means for stopping the segmenting if a handover decision is made,
wherein the means for performing the handover procedure is configured to perform the handover procedure only after all of the segments that are pending have been transmitted.

15. The apparatus of claim 12, wherein the apparatus is the user device or part thereof, and wherein the handover procedure comprises providing a handover confirmation after the segments are transmitted.

16. The apparatus of claim 15, also comprising means for stopping the segmenting if a handover command is received,
wherein the means for performing the handover procedure is configured to perform the handover procedure only after all of the segments that are pending have been transmitted.

17. The apparatus of claim 12, wherein the means for segmenting is configured to operate at a medium access control layer.

18. An apparatus comprising:
a segmenting module configured to segment a plurality of service data units;
a transmitting module configured to transmit segments produced by the segmenting module; and
a handover module, configured to perform a handover procedure after the segments are transmitted,
wherein the handover is for handing a user device from a source base station over to a target base station.

19. The apparatus of claim 18, wherein the apparatus is a network element located at the source base station, and wherein the handover procedure comprises issuing a handover command to the user device after the segments are transmitted.

20. The apparatus of claim 19, also comprising a cessation module configured to stop the segmenting if a handover decision is made,
wherein the handover module is further configured to perform the handover procedure only after all of the segments that are pending have been transmitted.

21. The apparatus of claim 18, wherein the apparatus is the user device or part thereof, and wherein the handover procedure comprises providing a handover confirmation after the segments are transmitted.

22. The apparatus of claim 19, also comprising a cessation module configured to stop the segmenting if a handover command is received,
wherein the handover module is further configured to perform the handover procedure only after all of the segments that are pending have been transmitted.

23. The apparatus of claim 18, wherein the segmenting module is configured to operate at a medium access control layer.

24. A software product comprising a computer readable medium having executable codes embedded therein; the codes, when executed, adapted to carry out the functions of:
segmenting a plurality of service data units;
transmitting segments produced by the segmenting; and
performing a handover procedure after the segments are transmitted,
wherein the handover is for handing a user device from a source base station over to a target base station.

25. The software product of claim 24, wherein the segmenting is performed at the source base station, and wherein the handover procedure comprises issuing a handover command to the user device after the segments are transmitted.

26. The software product of claim 25, wherein the functions also comprise stopping the segmenting if a handover decision is made,
wherein the handover procedure is performed only after all of the segments that are pending have been transmitted.

27. The software product of claim 24, wherein the segmenting is performed at the user device, and wherein the handover procedure comprises providing a handover confirmation after the segments are transmitted.

28. The software product of claim 27, wherein the functions also comprise stopping the segmenting if a handover command is received,
wherein the handover procedure is performed only after all of the segments that are pending have been transmitted.

29. A system comprising:
a user device;
a source base station; and
a target base station;
wherein a segmenting module is configured to segment a plurality of service data units, and a transmitting module is configured to transmit segments produced by the segmenting module on a wireless link between the user device and the source base station;
wherein a handover module is configured to perform a handover procedure after the segments are transmitted; and
wherein the handover is for handing the user device from the source base station over to the target base station.

30. The system of claim 29, wherein a threshold is configured that limits the method to cases in which only a given percentage or number of segments are missing.

31. The system of claim29, wherein the segmenting occurs at a medium access control layer.
